(19) United States
(12) Patent Application Publication
(10) Pub. No.: US 2014/0327980 A1
(43) Pub. Date: Nov. 6, 2014

(54) Vehicle Internal Rear View Mirror Assembly

(71) Applicant: Sun Way Shue, Newark, CA (US)

(72) Inventor: Sun Way Shue, Newark, CA (US)

(21) Appl. No.: 13/886,286

(22) Filed: May 3, 2013

(51) Int. Cl. B60R 1/02

(52) U.S. Cl. CPC B60R 1/02
USPC 359/854

(57) ABSTRACT

A three mirror assembly provides wide-angle rear view including blind spots for a vehicle. The center one is regular flat mirror. The other two are progressive convex mirrors that are side attached to the center one and are adjustable and detachable independently to suit vehicle operator's sitting postures and preference.

### BACKGROUND OF THE INVENTION

### Field of invention

The present invention relates to rear view mirror design for vehicles.

The prior rear view mirror systems still cannot cover the blind spot when driver operates a vehicle unless taking extra actions like turning eyes around. And it's impossible for driver to observe the traffic status of left and right blind spots simultaneously.

Therefore it is desirable and safer for the drivers to reduce head movements and to observe the rear and side traffic conditions without any blind spot.

### BRIEF DESCRIPTION OF THE DRAWINGS

FIG. 1: Isometric front view of an embodiment of a rear view mirror assembly in accordance with the present invention;

FIG. 2: Isometric bottom view.

FIG. 3: Bottom view of an embodiment.

FIG. 4: Front view of an embodiment.

FIG. 5: Top view of an embodiment.

FIG. 6: Enlarged isometric view of the clamping clip pair of FIG. 1.

FIG. 7: Isometric view of side mirror of FIG. 1.

FIG. 8: Side view of side mirror of FIG. 1.

### DETAILED DESCRIPTION OF THE INVENTION

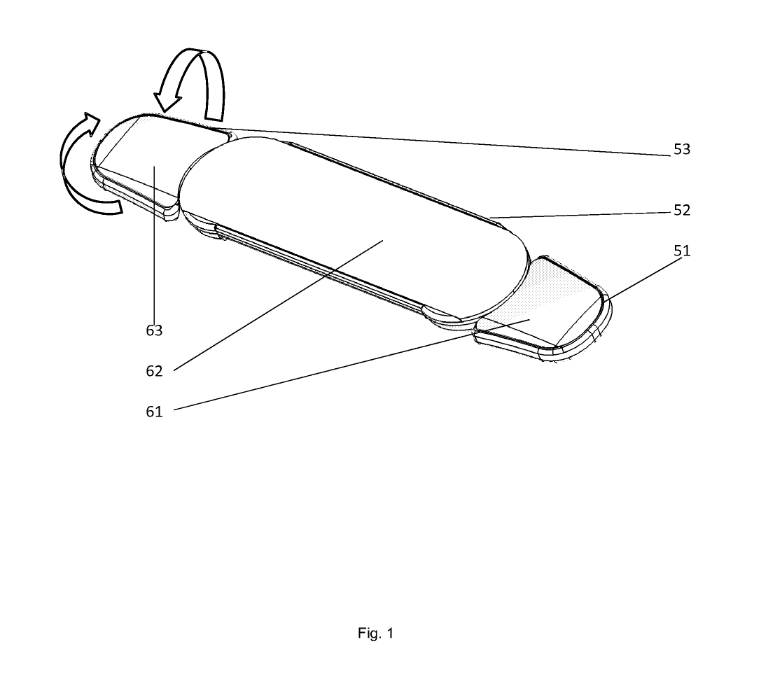

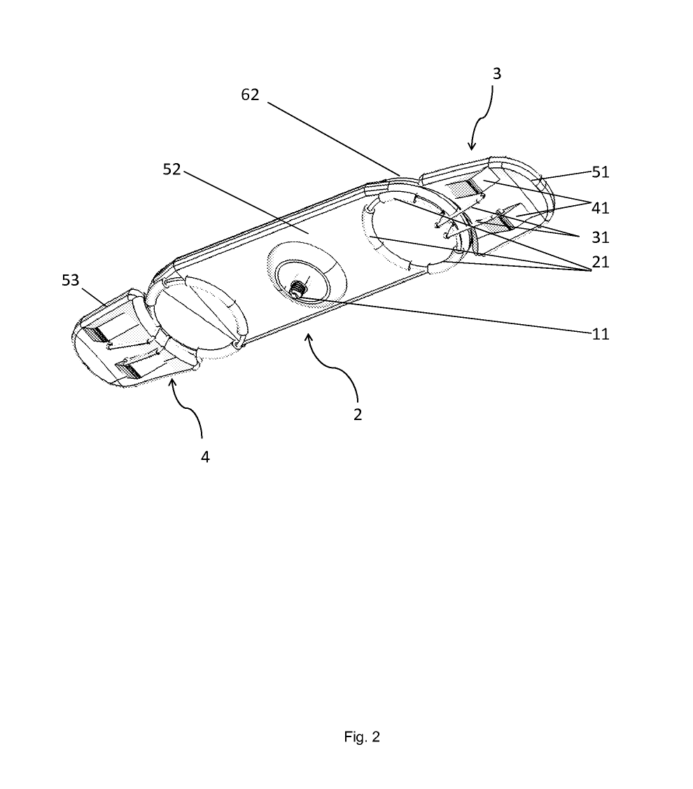

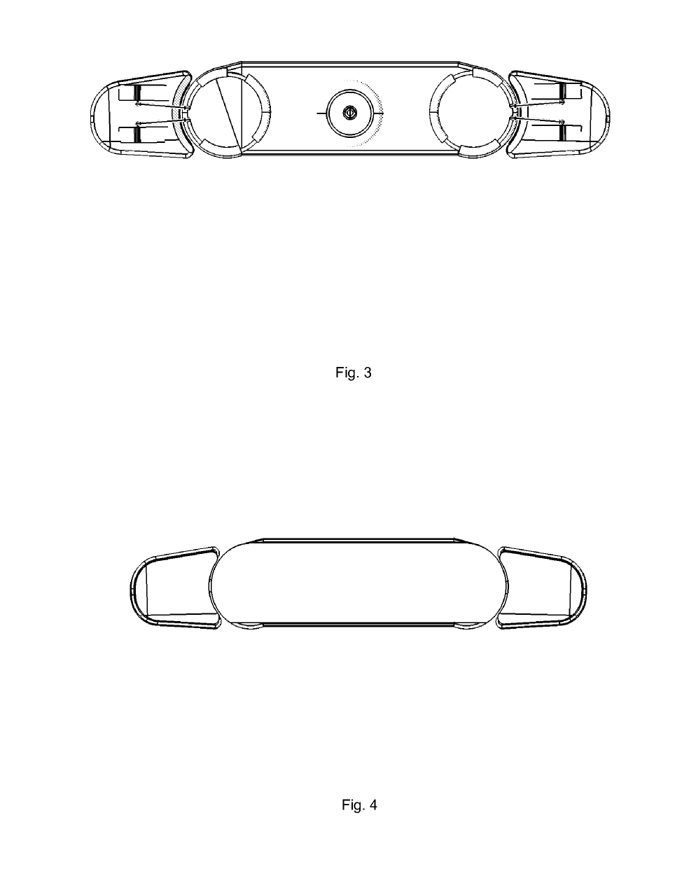

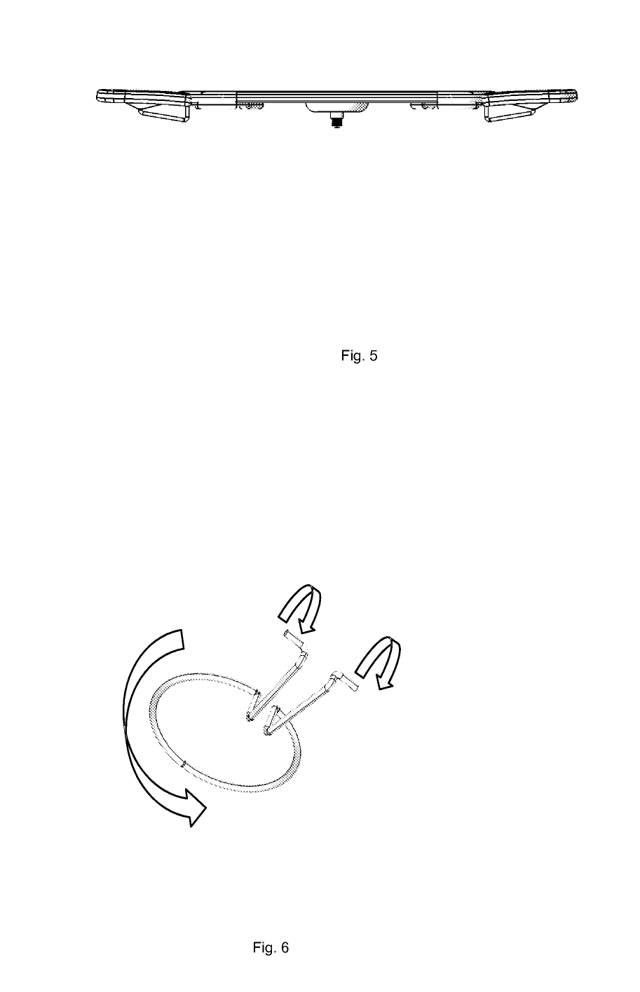

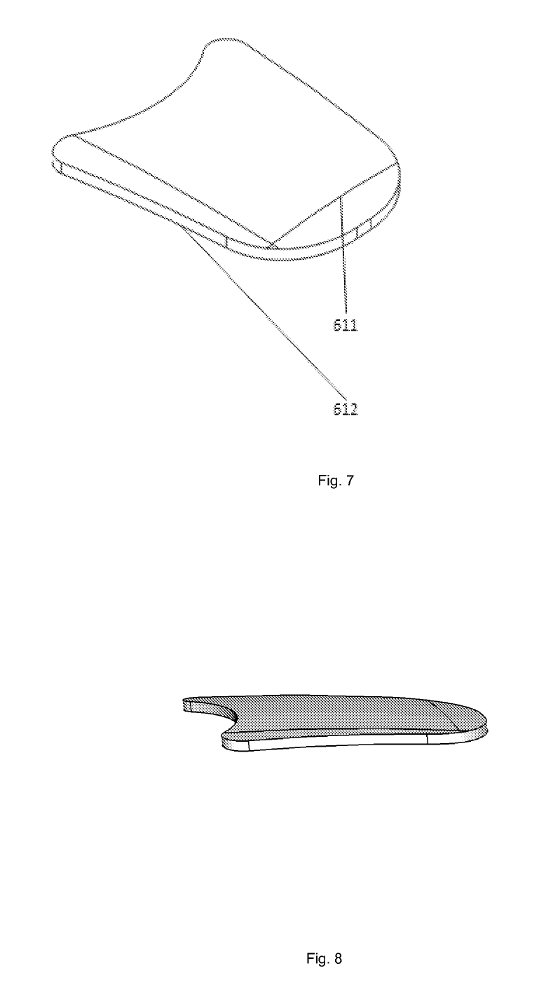

FIG. 1 is the isometric view of a rear view mirror assembly formed with a center frame 52 where a screw 11 embedded for connecting to the mounting mechanism (not shown) of vehicle's windshield rear mirror. The right side frame 51 and left side frame 53 as illustrated in FIG. 2., two pairs of clips 31 as illustrated in FIG. 6, center mirror 62 and progressive side mirrors 61,63 fabricated on the top of frame 52, 51, 53 respectively.
The center frame 52 is edged for plate mirror mounting. At the left and the right ends are curved for circular rotation movements for side mirror sections 3, 4.
Shown as FIG. 2, the back of center frame 52 is fabricated with a pair of non-continuous circular grooves 21 where the clips 31 are routed into to provide rotation movements of side mirror sections 3, 4 as desired.
Shown as FIG. 2, the back of side frames 51, 53 are integrated with pivot bosses 41 where the clips 31 are inserted into to provide swiveling movements relatively to the center frame 52 as desired.
The center frame 52 is mounted on its top with flat reflective mirror 62 in FIG. 1.
On the tops of side frames 51, 53 are mounted on with progressive convex mirrors 61, 63 respectively as shown in FIG. 1.
The side progressive mirrors 61, 63 as shown in FIG. 7, 8 are designed with different curvatures 611, 612 in accordance with different orientations and locations to minimize the distortion of images.
The side progressive mirrors 61, 63 in FIG. 8 are mounted on the frames 51, 53 with preset angle to saturate with images of targeted objects.
The frames 51, 52, 53 can be made of plastics, metal alloy or metal alloy over molded with plastic. And the clips 31 are stainless steel wires.
Tight fittings assembly is applied to provide the frictions to hold desired position against the vibration during vehicle's operating.

### SUMMARY OF THE INVENTION

The present invention is to provide vehicle drivers rear and side images of traffic status without blind spots.

Accordingly, it is an object of present invention to provide the adjustability to suit driving postures and driver's size.

The side mirror units can be adjusted individually to optimize the images of vehicle's blind spots for both sides.

The present invention is interior apparatus of a vehicle for the owner to possess more security and convenience of the estate.

The side units can be detached from or mount on the center unit manually without special tools.

What is claimed is:

1. A rear view mirror assembly, comprising:
A center frame is equipped with flat reflective mirror and is attached by wire clips with two side frames that equipped with progressive convex mirrors individually.

2. The featured circular grooves on the center unit and corresponding clips provide the right and left mirrors rotational movements with the range more than 45 degrees.

3. The side mirrors are progressive convex reflective surfaces to minimize the distortion of targeted images.

4. The apparatus as denoted in claim 1, the center mirror has a flat reflective surface.

5. Each side frame has two pivot bosses to adopt the clips linked with center frame to provide swiveling movements relatively with the range over 30 degrees as set forth in claim 1.

6. In claim 5, two bosses are arranged in opposite mounting directions to perform the security of the fitting for clips.

7. The progressive convex mirrors mounted on the side frames are preset with particular angle to saturate itself with the reflected images.
